(19) United States
(12) Patent Application Publication
(10) Pub. No.: US 2016/0214176 A1
(43) Pub. Date: Jul. 28, 2016

(54) METHOD OF INDUCING POROUS STRUCTURES IN LASER-DEPOSITED COATINGS

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/333,543

(22) Filed: Jul. 17, 2014

Related U.S. Application Data
(63) Continuation-in-part of application No. 14/274,952, filed on May 12, 2014.

(51) Int. Cl. B22F 3/11; B22F 5/04; B23K 26/342; B22F 3/105; C23C 24/10; C23C 24/08

(52) U.S. Cl. CPC B22F 3/1125; C23C 24/103; C23C 24/085; B23K 26/342; B22F 3/1055; B22F 5/04

(57) ABSTRACT

A layer of a powdered material (4) is heated with an energy beam (10) such that at least one gas-generating agent (8) reacts to form at least one gaseous substance (14) to produce a void-containing coating (16) adhered to the surface of a substrate (2).

The powdered material may contain a metallic material, a ceramic material, or both, and may also contain at least one of a flux material (32) containing the gas-generating agent and an exothermic agent (64). The heating may occur using a laser beam and may induce a melting or sintering of the powdered material to produce the void-containing coating. A gas turbine engine component exhibiting improved thermal and mechanical properties may be formed to include the void-containing coating, which may take the form of a bond coating, a thermal barrier coating, or both.

This application is a continuation-in-part of U.S. patent application Ser. No. 14/274,952 filed on 12 May 2014 (attorney docket 2014P07212US), the entire contents of which are incorporated herein by reference.

### FIELD OF THE INVENTION

This invention relates generally to the field of materials technology, and more specifically to methods of forming void-containing metal forms and components formed thereof.

### BACKGROUND OF THE INVENTION

Thermal barrier coatings (TBCs) are utilized on hot section components of modern gas turbine engines, including the combustion and turbine section components, in order to protect the underlying base materials from high temperatures resulting from the flow of hot gases through the engine. These hot gases can be well above the melting point of the base materials which are typically superalloy materials. In the evolution of such technologies, there is an ongoing need to produce coatings having a low thermal conductivity (to impart heat resistance to coated objects) while at the same time exhibiting robust strength and durability characteristics in terms of resistance to cracking, erosion, corrosion, impact fatigue/failure, impurity infiltration and de-lamination (i.e. spallation).

Heat resistance is often the limiting feature in the performance of modern gas turbine engines. For example, it is known that an increase of 100° F. (56° C.) in the turbine's firing temperature can provide a corresponding increase of 8-13% in output and 2-4% of improvement in simple-cycle efficiency. Thus, advances in cooling and coating technologies can provide significant incentives by increasing the power density and overall efficiency of a gas turbine engine.

Based on economic, environmental and overall-performance considerations, there is significant need to develop new materials and methods for increasing the heat resistance of gas-turbine components.

Ceramic TBCs are generally applied to an intermediate bond coat overlying the metal substrate. Suitable ceramic TBC materials include zirconia-containing materials—particularly chemically-stabilized zirconias (e.g., zirconium oxides blended with other metal oxides) such as yttria-stabilized zirconias (YSZs). The bond coat typically takes the form of an intermediate adhesion layer, which is often an alloy of the formula MCrAIX (in which “M” represents Fe, Ni or Co, and “X” represents Ta, Re, Y, Zr, Hf, Si, B or C), a simple aluminide (NiAI), or a platinum-modified aluminide ((Ni, Pt)AI). Most typically, the bond coat is an intermediate layer containing an alloy of MCrAIY.

Although bond coat materials such as MCrAlYs have proven effective as an intermediate layer to enhance adhesion and to accommodate differences in the thermal expansion between superalloy substrates and ceramic TBCs, the use of such layers is disadvantageous in terms of the complexity and cost of their production. This is true, for example, because MCrAIY layers are often applied using expensive and complex processes such as vapor deposition and various spraying techniques. There is also a significant need to develop alternative materials and methods to effectively adhere ceramic TBCs to the surface of metallic gas turbine components including superalloy components.

### BRIEF DESCRIPTION OF THE DRAWINGS

The invention is explained in the following description in view of the drawings that show:

FIG. 1 illustrates a method of using a powdered material in the presence gas-generating agent to produce a void-containing coating adhered to the surface of a substrate.

FIG. 2 is a cross-sectional view of a porous bond coat adhered directly to the surface of a superalloy substrate.

FIG. 3 illustrates a method of using a powdered material in the presence of a flux material containing a gas-generating agent to produce a porous metallic and/or ceramic coating covered by a porous slag layer.

FIG. 4 illustrates a method of using a powdered material to produce a void-containing coating in which porous voids are formed using a gas-generating agent directed into a melted pool of a metallic and/or ceramic material with a gas jet.

FIG. 5 illustrates a method of using a powdered material in the presence of both a gas-generating agent and an exothermic agent to produce a void-containing coating in which the exothermic agent provides additional heating after the application of an energy beam.

FIG. 6 is a cross-sectional view of a gas turbine engine blade having a porous superalloy coating along its leading and trailing edges.

### DETAILED DESCRIPTION OF THE INVENTION

The present inventors have discovered methods for coating substrates, including superalloy substrates, with metallic and/or ceramic materials to produce porous (void-containing) coatings having improved properties such as reduced thermal conductivity, increased adherence, and greater resistance to cracking, impact damage and spalling. The present inventors have innovatively developed a combination of steps for manufacturing coated materials having improved thermo-protective properties as well as coated materials produced using simpler coating and bonding techniques amenable to a variety of high-temperature applications and applications requiring robust bonding between layers.

One embodiment of the present invention is a method involving the application of an energy beam to a powdered material in contact with a substrate, such that a gas-generating agent undergoes a chemical reaction to produce a gaseous substance that imparts voids (pores) to a resulting coating adhered to the substrate. Another embodiment of the present invention is a method involving the application of an energy beam to a powdered material in contact with a substrate, such that a void-generating agent undergoes a physical process that imparts voids (pores) to a resulting coating adhered to the substrate. For example, during laser sintering of a ceramic such as zirconia, a fluxing agent such as a carbonate of calcium could be added. Laser induced decomposition of this compound could generate sufficient carbon monoxide and carbon dioxide to assist physical separation of the zirconia particulates for a sufficient time to enable sintering of the particulates without their full densification.

The term “energy beam” is used herein in a general sense to describe a narrow, propagating stream of particles or packets of energy. An energy beam as used in the present invention may include a light beam, a laser beam, a particle beam, a charged-particle beam, a molecular beam, etc., which upon contact with a material imparts kinetic (thermal) and/or electronic energy (or excitation) to the material.

The term “powdered material” is used herein in a general sense to describe a mixture, grouping, or aggregation of objects in particulate form. Powdered materials may include powdered metals, powdered alloys, powdered ceramics, powdered flux materials, powdered plastics, powdered glasses, powdered composites, powdered compounds, as well as other powdered ingredients, and mixtures thereof.

The terms “metal” and “metallic material” are used herein in a general sense to describe pure metals, semi-pure metals and metal alloys.

The term “superalloy” is used herein in a general sense to describe a highly corrosion and oxidation resistant alloy that exhibits excellent mechanical strength and resistance to creep at high temperatures, as well as good surface stability. Superalloys typically include a base alloying element of nickel, cobalt or nickel-iron. Examples of superalloys include alloys sold under the trademarks and brand names Hastelloy, Inconel alloys (e.g., IN 700, IN 738, IN 792, IN 939), Rene alloys (e.g., Rene N5, Rene 80, Rene 142), Haynes alloys, Mar M, CM 247, CM 247 LC, C 263, 718, X-750, ECY 768, 282, X45, PWA 1483 and CMSX (e.g., CMSX-4, CMSX-8, CMSX-10) single crystal alloys.

The terms “ceramic” and “ceramic material” are used herein in a general sense to describe inorganic, non-metallic solids having a crystalline, partly crystalline, or amorphous structure and containing inorganic compounds such as inorganic oxides, nitrides or carbides. Especially useful ceramic materials include metal stabilized zirconias such as yttria-stabilized zirconia (YSZ) which is a crystalline ceramic structure containing zirconium dioxide and yttrium oxide.

The term “gas-generating agent” is used herein in a general sense to describe a substance or mixture of substances capable of undergoing a physical or chemical transformation to produce and/or release a gaseous substance, or to otherwise impart a void or voids to a heated, or melted, or solidifying material. In some embodiments, the gas-generating agent undergoes a chemical reaction or decomposition process upon heating to produce at least one gaseous substance. In some embodiments, the gas-generating agent reacts with an additional agent upon heating, or in the absence of heating, to produce at least one gaseous substance.

The term “gaseous substance” is used herein in a general sense to describe an element, compound, composition, or mixture thereof, which is in the gas phase and expands to fill any surrounding space or containing vessel.

The term “void-generating agent” is used herein in a general sense to describe a substance or mixture of substances capable of undergoing a physical transformation to produce a void or voids within a heated, melted, or solidifying material—or capable of causing a physical transformation to a heated, melted, or solidifying material to produce a void or voids within the resulting material.

The term “flux material” is used herein in a general sense to describe a chemical agent employed in metallurgical and welding processes as a cleaning agent, flowing agent, purifying agent and/or shielding agent. Flux materials may be organic fluxes or inorganic fluxes, and may contain metal halides (such as zinc chloride and calcium fluoride), inorganic acids (such as hydrochloric acid, phosphoric acid and hydrobromic acid), mineral acid salts, organic acids (including fatty acids such as oleic acid and stearic acid) and dicarboxylic acids, organohalides, rosin compounds (such as abietic acid, pimaric acid, and other resin acids), polyols and solvents. Especially useful flux materials are the inorganic fluxes containing borax, borates, fluoroborates, metal halides (e.g, metal fluorides, metal chlorides, halogenides), acids and amines.

The terms “voids” and “void” are used herein in a general sense to describe spaces within a solid or liquid material, in which spaces may exist a gaseous substance or a mixture of gaseous substances, or in which spaces may exist a non-gaseous substance, a mixture of non-gaseous substances, or a mixture of gaseous and non-gaseous substances, or where the spaces may be empty. Any contents of the voids or void are generally distinguishable from the surrounding matrix of the solid material, advantageously and often in a manner resulting in a reduction in the thermal conductivity of the solid material relative to the same material without the void or voids. The shape of the voids or void is not limited and may include porous volumes of various sizes and shapes having regular, irregular, symmetrical, and non-symmetrical surfaces. Within a coating produced by an embodiment of the present invention, a void or voids may vary in size, shape and distribution.

The term “substrate” is used herein in a general sense to describe an object to which a coating is applied, or in which a coating is to be applied. Suitable substrates applicable to the present invention may include metallic substrates, ceramic substrates, glass substrates, plastic substrates, composite substrates, paper substrates, etc.

The term “surface” is used herein in a general sense to describe the surface of an uncoated, coated, or partially-coated substrate or material.

The terms “melt” or “melting” are used herein in a general sense to describe physical processes that result in a phase transition of a substance from a solid phase to the liquid phase by the application of radiation (e.g., heat) or pressure resulting in a rise in the temperature of the substance to its melting point. While these terms include situations in which there may be incomplete melting resulting in a mixture of both solid and liquid phases, their use is intended to distinguish the described process from sintering processes defined below.

The terms “sinter” and “sintering” are used herein in a general sense to describe physical processes in which powders, including metallic and ceramic powders, are transformed into objects based on atomic diffusion—as opposed to melting resulting in a phase transition of the powder into a liquid phase, although some surface melting of the powder may occur. In a sintering process of the present invention, the atoms in the powder particles diffuse across the boundaries of the particles, fusing the particles together and creating one solid piece. This diffusion is caused by a gradient of chemical potential—such that atoms move from an area of higher chemical potential to an area of lower chemical potential. The atoms may follow different paths to get from one position to another. These different paths occur by different sintering mechanisms.

In some embodiments the powdered material contains a material that produces or contains the base components of a structural substrate, a bond coating, or a thermal barrier coating (TBC). Examples of the materials contained in the powdered material include metallic materials, ceramic materials, glass material and plastic materials.

In some embodiments the powdered material contains the gas-generating (or void-generating) agent; while in other embodiments the powdered material does not initially contain the gas-generating (or void-generating) agent, and the gas-generating (or void-generating) agent is added to the powdered material before or after the application of the energy beam to the powdered material.

Embodiments of the present invention include both melting and sintering processes. In melting processes the energy beam melts the powdered material to form a melt pool, in which the gaseous substance is formed or directed, and the melt pool is then allowed to cool and solidify to form a void-containing coating. In sintering process the energy beam heats the powdered material such that atomic diffusion of the powder particles occurs over a certain timeframe to produce (upon cooling) a sintered coating.

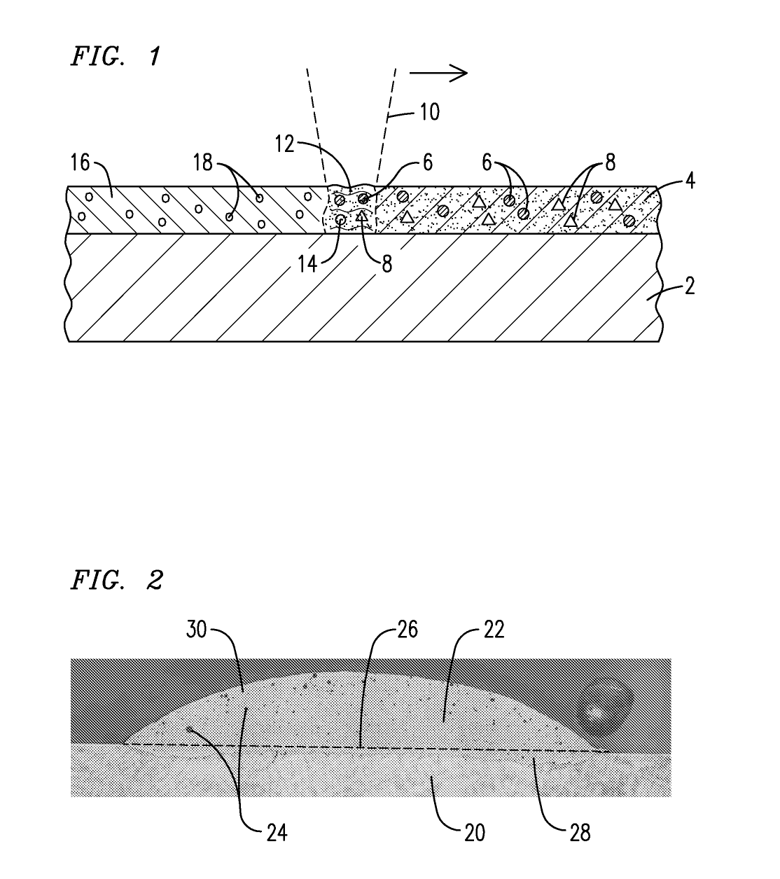

FIG. 1 illustrates a coating method applicable to both melting and sintering processes. In this process a layer 4 of a powdered material is pre-placed or fed onto the surface of a substrate 2. The layer 4 in this embodiment contains a metallic and/or ceramic material 6 and a gas-generating agent 8. The coating method is carried out by traversing an energy beam 10 across the layer 4 to create a heated region 12 containing the metallic and/or ceramic material 6 and the gas-generating agent 8. As a result of the heat imparted by the energy beam 10, the gas-generating agent 8 in this embodiment undergoes a chemical reaction to produce a gaseous substance 14. The gaseous substance 14 is contained within the heated region 12 and, upon cooling of heated material, becomes entrapped within a forming coating to produce voids 18 within the resulting void-containing coating 16.

In some embodiments the void-containing coating 16 is thermal barrier coating (TBC) in the form of a porous layer of a ceramic material bonded directly to the surface of a metallic substrate (such as a superalloy substrate). In other embodiments the void-containing coating 16 is a thermal barrier coating (TBC) in the form of a porous layer of a ceramic material bonded to an intervening bond coat layer which is bonded to the surface of a metallic substrate (such as a superalloy substrate). Thus, coating methods of the present invention can advantageously be applied directly to the surface of a substrate or, alternatively, may be applied to an intermediate layer (such as a bond coat) already present on the surface of the substrate.

In some embodiments the void-containing coating 16 is a bond coat in the form of an alloy material (such as an alloy of MCrAIY) bonded directly to the surface of a metallic substrate (such as a superalloy substrate). In other embodiments the void-containing coating 16 is porous metallic or alloy material bonded directly to the surface of a metallic substrate (such as a superalloy substrate)—such that the composition of the void-containing coating 16 (in terms of its elemental composition) may be identical to that of the metallic substrate or different from that of the metallic substrate.

Some embodiments enable the formation of a ceramic thermal barrier coating bonded to the surface of a metallic (superalloy) substrate without the need for a traditional (e.g., MCrAIY) bond coat. One variation of such embodiments involves the application of an intermediate porous bond coat, containing a similar or identical composition to that of the metallic (superalloy) substrate, upon which a ceramic thermal barrier coating is applied using tradition methods or using methods of the present invention.

FIG. 2 shows the cross-sectional view of a porous bond coat produced by one embodiment of the present invention. In FIG. 2 a metallic (superalloy) substrate 20 is coated with a porous void-containing coating 22 containing yttrium (Y). This bond coat resulted from the laser cladding of a powdered material containing yttrium—in which the yttrium itself served as the gas-generating agent.

Key features depicted in the coated substrate of FIG. 2 include the presence of relatively-small (fine) pores 24 within the void-containing coating 22. These pores 24 are heterogeneously distributed along the length and depth of the coating 22, and are predominantly non-connected (non-coalesced) pores.

The ability to produce a heterogeneous coating of fine pores 24, which are predominantly non-connected (non-coalesced), is an important feature which is believed to be responsible in part for the improved mechanical and thermal properties of coatings of the present invention. In terms of thermal conductivity, the ability to control pore size, distribution and (to a certain extent) shape allows the thermal characteristics of TBCs and bond coats to be tuned and modulated in key portions of hot section components. Non-coalescence of the pores 24 is believed to improve crack resistance and to reduce impact fatigue and failure, because spherically-uniform (singular) pores are known to arrest cracks which inevitably form in coating structures. Thus, when cracks do form they can be arrested by an adjoining pore—thereby, preventing propagation of the crack into the underlying substrate 20. Coalesced pores would be expected to reduce crack resistance, because their elongated shape would tend to further propagate cracks.

Other important features depicted in FIG. 2 include the presence of a relatively rough coating surface 30 and an intermediate bond interface layer 28. The relatively rough texture of the coating surface 30 would be expected to enhance the adherence of a TBC (not shown in FIG. 2) to the surface of the void-containing coating 22. The intermediate bond interface layer 28 would similarly be expected to enhance the bonding of the bond coat 22 to the metallic substrate 20. This is especially the case for embodiments in which the heating of the powdered material results in the melting of the powdered material—which can lead to the melting of a thin, upper layer of the substrate 20 surface. As shown in FIG. 2, such melting of the upper surface of the substrate 20 leads to the removal (i.e., etching) of the upper surface of the substrate 20 in which the bond interface 28 ultimately forms (presumably as hybrid alloy containing constituents of both the metallic substrate 20 and the void-containing coating 22). The presence of the bond interface 28 is expected to improve adherence of the bond coat 22 to the metal substrate 20, leading to reduced spalling of a resulting coating (i.e., TBC) adhered to the substrate.

Gas-generating agents (GGAs) may include any substance which when heated is capable of undergoing a chemical reaction, either by itself or in the presence of an additional agent, to form a gaseous material. The suitability of a particular gas-generating agent will depend not only on its reactivity characteristics but also on the suitability of the resulting gaseous substance as a constituent of the resulting void-containing coating. Gaseous substances may include gases such as hydrogen (H₂), carbon dioxide (CO₂), carbon monoxide (CO), nitrogen (N₂), oxygen (O₂), water (H₂O), hydrofluoric acid (HF), hydrochloric acid (HCl), sulfuric acid (H₂SO₄), fluorine (F₂), nitrogen dioxide (NO₂) and sulfur dioxide (SO₂). In some embodiments the gaseous substance entrapped within a void (pore) may react or otherwise interact with the surrounding material to form a largely empty void (pore).

Examples of suitable gas-generating agents include elemental metals, metal alloys, metal oxides, metal hydrides, metal carbonates, metal carbonyls, metal carbides, metal halides, metal nitrides, metal nitrates, metal sulfates and mixtures thereof.

One preferred set of gas-generating agents includes water-reactive metals and metal compounds that react with water to form at least one gaseous substance. GGAs of this type generally react with water to form hydrogen. Examples of such reactions include the reaction of titanium hydride with water as shown in equation (I), and the reaction of yttrium with water as shown in equation (II):

TiH₂+2 H₂O→Ti(OH)₂+H₂ (I)

2 Y+6 H₂O→Y₂(OH)₃+3 H₂ (II)

Suitable water-reactive metals and metal hydrides include those containing elements within Groups IA, IIA, IIIB, IVB, VB, VIB, VIIB, VIIIB, IB, IIB, IIIA and IVA of the Periodic Table. Particularly suitable water-reactive metals and metal hydrides include those containing elements within Periods 3-6 of the Period Table—such as Al, Ti, V, Cr, Mn, Fe, Co, Ni, Cu, Zn, Y, Zr, Nb, Mo, Pd, Ag, In, Sn, Hf, Os, Pt, Au, Hg and Pb. Especially preferred water-reactive metals and metal hydrides include those containing the elements Al, Ti, V, Cr, Fe, Co, Ni, Y and Zr.

Other gas-generating agents include thermally-labile compounds that decompose or otherwise react to form gaseous products such as carbon dioxide. One example of such a reaction is the thermal decomposition of copper carbonate to form carbon dioxide as shown below in equation (III):

CuCO₃→CuO+CO₂ (III)

Suitable metal carbonates include those containing elements within Groups IA, IIA, IIIB, IVB, VB, VIB, VIIB, VIIIB, IB, IIB, IIIA and IVA of the Periodic Table. Particularly suitable metal carbonates include those containing elements within Periods 3-6 of the Period Table—such as Al, Ti, V, Cr, Mn, Fe, Co, Ni, Cu, Zn, Y, Zr, Nb, Mo, Pd, Ag, In, Sn, Hf, Os, Pt, Au, Hg and Pb. Especially preferred metal carbonates include those containing the elements Al, Ti, V, Cr, Fe, Co, Ni, Y and Zr. Still other carbonates could include magnesium and calcium carbonate to generate gaseous products.

Another example of such a reaction is the thermal reaction of calcium fluoride with an acidic source to form hydrofluoric acid as shown below in equation (IV):

CaF₂+H₂SO₄→CaSO₄+2 HF (IV)

Suitable metal fluorides include those containing elements within Groups IA, IIA, IIIB, IV, VB, VIB, VIIB, VIIIB, IB, IIB, IIIA and IVA of the Periodic Table. Particularly suitable metal fluorides include those containing elements within Periods 3-6 of the Periodic Table. Especially preferred metal fluorides include those commonly found in flux materials, such as calcium fluoride.

Other gas-generating agents include certain metallic oxides which, in the environment of plasma generated by a laser beam, can react to form reactive metals or metal compounds. One example of a metallic oxide capable of forming a reactive metal when heated with a laser beam is yttrium oxide (Y₂O₃). Suitable metal oxides include those containing elements within Groups IIIB, IVB, VB, VIB, VIIB, VIIIB, IB, IIB, IIIA and IVA of the Periodic Table. Particularly suitable metal oxides include those containing elements within Periods 4-6 of the Period Table—such as Ti, V, Cr, Mn, Fe, Co, Ni, Cu, Zn, Y, Zr, Nb, Mo, Pd, Ag, In, Sn, Hf, Os, Pt, Au, Hg and Pb. Especially preferred metal oxides include those containing the elements Ti, V, Cr, Fe, Co, Ni, Y and Zr.

In some embodiments the process further includes, prior to the heating with the energy beam, a step of exposing the powdered material to humidity in order to retain water which can react with certain gas-generating agents and the laser energy to form the gaseous substance.

The proportion of the gas-generating agent in the heated region ranges from 0.1 to 50 wt. % in various embodiments.

In some embodiments a preferred porosity of the void-containing layer ranges from 1% by volume to 50% by volume. In other embodiments (e.g., certain foamed metals) a porosity of the void-containing layer is at least 50% by volume, and advantageously from 50% to 85% by volume.

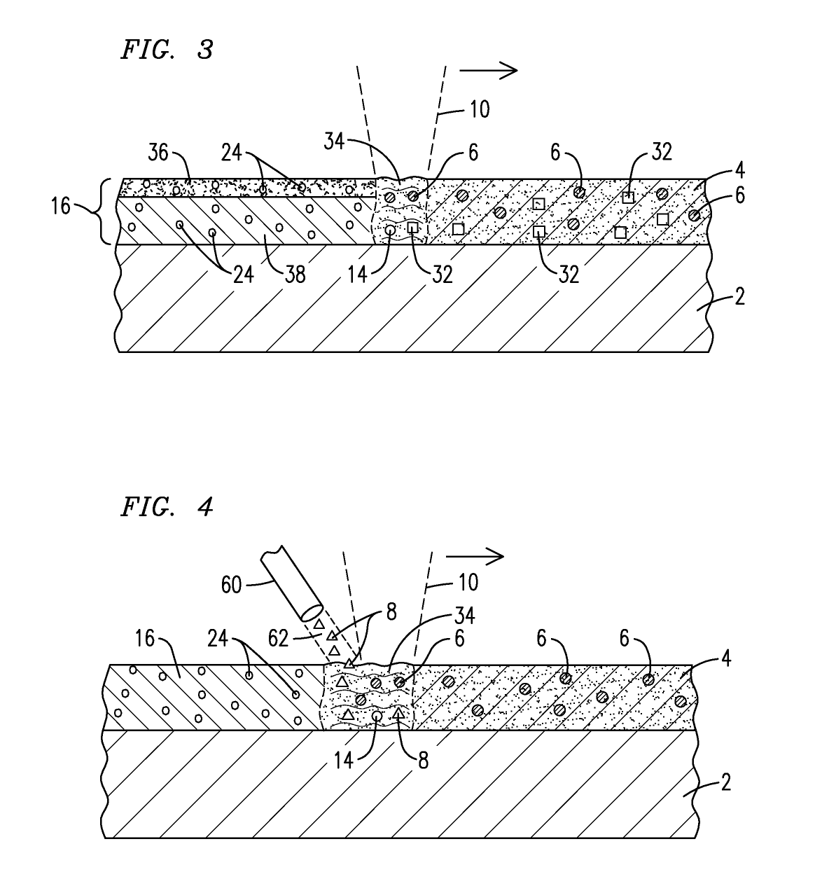

FIG. 3 illustrates another embodiment in which a layer 4 of a powdered material containing a metallic and/or ceramic material 6 and a flux material 32 containing a gas-generating agent is melted by traversing an energy beam 10 across the layer 4 to create a melt pool 34 containing the metallic and/or ceramic material 6 and the flux material/gas-generating agent 32. As a result of the heat imparted by the energy beam 10, the gas-generating agent 32 in this embodiment undergoes a chemical reaction to produce a gaseous substance 14. The gaseous substance 14 is contained within the melt pool 34 and, upon cooling and solidification of the melted material, becomes entrapped within a forming coating to produce porous voids 24 within the resulting void-containing coating 16. In this embodiment the presence of the flux material results in a void-containing coating made up of a porous metallic and/or ceramic layer 38, which is directly bonded to the substrate 2, and a porous slag layer 36 covering the porous metallic and/or ceramic layer 38.

The flux material 32 and the resultant slag layer 36 provide a number of functions that are beneficial to the porous metallic and/or ceramic coating 38.

First, they function to shield both the region of molten material and the solidified (but still hot) cladding 38 from the atmosphere in the region downstream of the energy beam 10. The slag floats to the surface to separate the molten or hot metal/ceramic from the atmosphere, and the flux may be formulated to produce a shielding gas in some embodiments, thereby avoiding or minimizing the use of expensive inert gas.

Second, the slag 36 acts as a blanket allowing the solidified material to cool slowly and evenly, thereby reducing residual stresses than can contribute to post weld reheat or strain age cracking.

Third, the slag 36 helps to shape the melt pool 34 to keep it close to a desired height/width ratio. In some embodiments the height/width ratio is preferably a ratio of ⅓.

Fourth, the flux material 32 provides a cleansing effect for removing trace impurities such as sulfur and phosphorous which contribute to weld solidification cracking. Such cleansing may include de-oxidation when the powdered material contains a metal powder. Because the flux powder is in intimate contact with such a metal powder, it is especially effective in accomplishing this function.

Fifth, the flux material 32 may provide an energy absorption and trapping function to more effectively convert the energy beam 10 into heat energy, thus facilitating a more precise control of heat input, such as within 1-2%, and a resultant tight control of material temperature during the melting/solidifying process.

Sixth, the flux material 32 may be formulated to compensate for loss of volatized elements during the processing or to actively contribute elements to the melt flow 34 that are not otherwise provided by the powder material itself.

Finally, as illustrated in the embodiment of FIG. 3, the flux material 32 may also be formulated to deliver the gas-generating agent to the melt pool 34. In one preferred embodiment the flux material is a metal fluoride, such as calcium fluoride (CaF₂). Advantageously, the flux material is highly enriched (at least 30% by volume) with calcium fluoride.

FIG. 4 illustrates another embodiment in which a layer 4 of powdered material containing a metallic and/or ceramic material 6 is pre-placed or fed onto the surface of a substrate, and then an energy beam 10 is traversed across the layer 4 to create a melt pool 34 containing the metallic and/or ceramic material 6. Downstream of the energy beam 10, one or more nozzles 60 are used to direct a jet 62 containing a propellant gas and a gas-generating agent 8 into the melt pool 34. Upon heating within the melt pool 34 the gas-generating agent 8 undergoes a chemical reaction to produce a gaseous substance 14. The gaseous substance 14 is contained within the melt pool 34 and, upon cooling and solidification of the melted material, becomes entrapped within a forming coating to produce porous voids 24 within the resulting void-containing coating 16.

The embodiment of FIG. 4 is especially useful in processes in which the proportion of voids 24 (i.e., porosity) within the void-containing coating 16 is modulated along the lengthwise direction of the coating. In these embodiments the concentration of the gas-generating agent 8 (and the resulting porous voids 24) can be altered by altering the concentration of the gas-generating agent 8 in the propellant gas.

The embodiment of FIG. 4 is also especially useful in processes in which the proportion of voids tends to increase near the surface of the coating (due to floatation of the gaseous substance 14). In these embodiments the use of the jet 62 downstream of the energy beam allows application of the gas-generating agent to the cooling melt pool 34 with a higher degree of temperature control, such that floatation of the gaseous substance 14 can be minimized prior to solidification of the melt pool 34. In other embodiments the effect of floatation may be mitigated by the application of external pressure to the cooling melt pool 34.

The embodiment of FIG. 4 is also especially useful in processes in which more than one gas-generating agent is applied to the melt pool 34, or in which a single gas-generating agent 8 is applied to the melt pool 34 at more than one location. In these embodiments the use of multiple gas-generating agents allows for the introduction of porous voids 24 containing different gaseous substances 14. In other embodiments the application of a single gas-generating agent 8 at multiple locations allows for the production of a void-containing coating 16 having a variable porosity along the length, width and/or depth of the resulting void-containing coating 16.

In other embodiments the powdered material, the flux material, the heated region, the melt pool and/or the jet may contain (or additionally contain) an exothermic agent which, upon heating with the energy beam, reacts over a time period to release additional heat. Embodiments employing the exothermic agent are especially useful in laser-induced sintering processes. In these embodiments use of the exothermic agent allows the use of a lower level of laser power to be applied which enables greater temperature control of the sintering processes. Such enhanced temperature control by using an exothermic agent can provide a more homogeneous heat distribution along the depth of the powdered material—thus producing porous sintered coatings having greater homogeneity and enhanced thermal and mechanical properties.

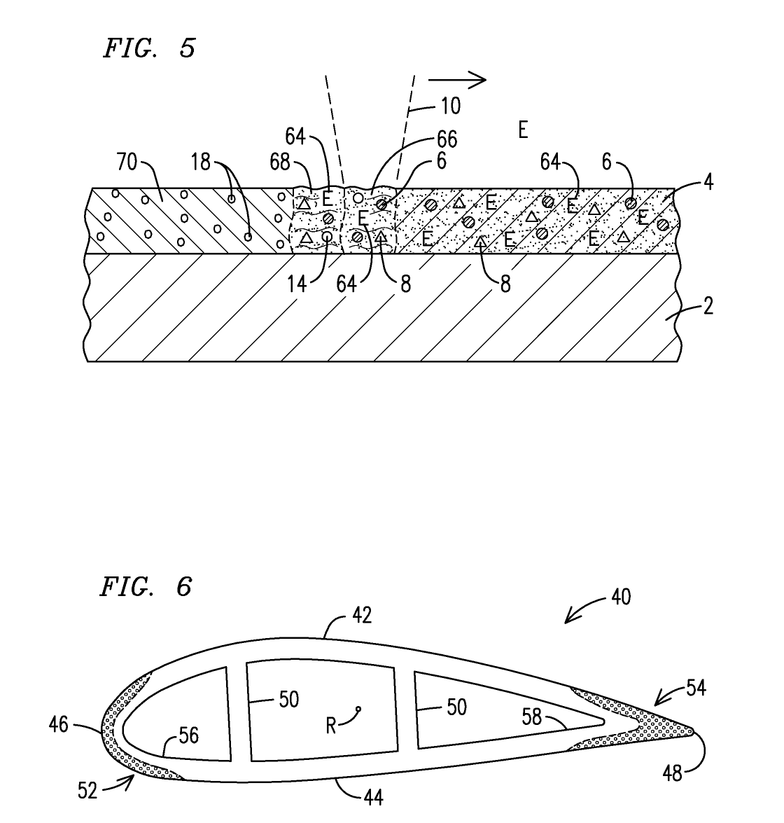

FIG. 5 illustrates another embodiment in which a layer 4 of a powdered material containing a metallic and/or ceramic material 6, a gas-generating agent 8, and an exothermic agent 64 is melted by traversing an energy beam 10 across the layer 4 to create an energy beam heated region 66 of sufficient temperature to initiate sintering of the powdered material. Within the energy beam heated region 66, the gas-generating agent 8 undergoes chemical reaction to produce a gaseous substance 14, and a portion of the exothermic agent 64 reacts to release additional heat. After the energy beam 10 has traversed the energy beam heated region 66, an unreacted portion of the exothermic agent 66 continues to react in an additional heating region 68 to release additional heat. Additional heat generated within the additional heating region 68 causes an unreacted portion of the gas-generating agent 8 to undergo chemical reaction to produce additional amounts of the gaseous substance 14, and continues to drive the sintering process. The gaseous substance 14 is contained within the sintering powdered material and occupies an area of the voids 18 to become entrapped with the resulting sintered coating 70.

In some embodiments the exothermic agent is contained within a flux material contained within the powdered material. In other embodiments the exothermic agent is contained within a flux material placed (layered) on top of a layer of the powdered material. In other embodiments the exothermic agent is directed into the sintering powder by use of a jet containing a propellant gas and the exothermic agent which is propelled into a heated region using a nozzle.

In some embodiments the exothermic agent is selectively placed, fed or directed into the powdered material to produce varying proportions of the exothermic agent along the length, width or depth of the powdered material—such that the degree of sintering in corresponding portions of the sintered coating is different.

The exothermic agent may be any substance that undergoes a chemical reaction to produce heat. In some embodiments the exothermic agent is metal, metal alloy or metal composition which reacts with oxygen to produce heat. One example of such a reaction is the combustion of zirconium metal with oxygen to form zirconium (II) oxide as shown below in equation (A):

Zr(s)+O₂→ZrO₂(s) (A)

Other examples of similar exothermic reactions which may be useful for specific applications (other material bases) include:

Fe₂O₃+2Al→2Fe+Al₂O₃ (iron thermite) (B)

3CuO+2Al→3Cu+Al₂O₃ (copper thermite) (C)

Mn, Cr and Si thermites and even fluoropolymers (e.g. Teflon plus Mg plus Al) may be utilized.

Suitable combustible metals include those containing elements within Groups IA, IIA, IIIB, IVB, VB, VIB, VIIB, VIIIB, IB, IIB, IIIA and IVA of the Periodic Table. Particularly suitable combustible metals include those containing elements within Periods 3-6 of the Period Table—such as Al, Ti, V, Cr, Mn, Fe, Co, Ni, Cu, Zn, Y, Zr, Nb, Mo, Pd, Ag, In, Sn, Hf, Os, Pt, Au, Hg and Pb. Especially preferred water-reactive metals and metal hydrides include those containing the elements Al, Ti, V, Cr, Fe, Co, Ni, Y and Zr. Especially preferred combustible metals include Al, Ti, Ni, Zr and Ni-Al alloys (e.g., nickel aluminides).

In some embodiments the energy beam 10 is a laser beam. In order to entrap the gaseous substance 14 produced by the gas-generating agent 8 within a re-solidifying molten metal to optimize the formation of porosity, it may be desired to achieve a relatively rapid melting and re-solidification of the melt pool 34. Therefore, in some embodiments the energy beam 10 is a pulsed laser beam rather than a continuous energy source. By pulsing relatively short bursts of relatively high levels of energy followed by periods of no energy addition, it is possible to more effectively trap relatively smaller pockets of the gaseous substance 14 in the solidifying metal than when applying the same total amount of energy with a continuous energy beam source.

In some embodiments, laser and process parameters are adjusted to achieve a stirring action to further enhance the function of the gas-generating agent 8. For example, a high density beam can create a vapor supported depression within a melt pool 34 which, when moved from side to side, can act as a stirring element. Parameters may also be adjusted to achieve waves in the melt and/or a breaking action to disrupt (break apart) coalesced bubbles in the melt pool 34.

In some embodiments the energy beam is a diode laser beam having a generally rectangular cross-sectional shape. Other known types of energy beams may also be used, such as electron beam, plasma beam, one or more circular laser beams, a scanned laser beam, an integrated laser beam, etc. A rectangular shape may be particularly advantageous for embodiments having a relatively large area to be coated. Optical conditions and hardware optics used to generate a broad area laser exposure may include but are not limited to: defocusing of the laser beam; use of diode lasers that generate rectangular energy sources at focus; use of integrating optics such as segmented mirrors to generate rectangular energy sources at focus; scanning (rastering) of the laser beam in one or more dimensions; and the use of focusing optics of variable beam diameter (e.g, 0.5 mm at focus for fine detailed work varied to 2.0 mm at focus for less detailed work). In some embodiments the motion of the optics and/or substrate may be programmed as in a selective laser melting (SLM) or selective laser sintering (SLS) process to build a custom shape layer deposit.

Some embodiments employ the use of a base alloy feed material. Such a feed material may be in the form of a wire or strip that is fed or oscillated towards the substrate 4 and is melted by the energy beam to contribute to the melt pool 34. If desired, the feed material may be preheated (e.g., electrically) to reduce the overall energy required from the energy beam 10.

Processes of the present invention may be used to manufacture various components. By example, FIG. 6 is a cross-sectional view of a gas turbine engine blade 40 manufactured using processes of the present invention. The blade 40 has an airfoil shape with a suction side 42 and a pressure side 44 extending from a leading edge 46 to a trailing edge 48. The blade 40 contains porous regions 52 and 54 that were produced by a method of the present invention in which a superalloy substrate was coated by a melting or sintering process in the presence of a gas-generating agent. The gas-generating agent produced a gaseous substance which is responsible for the formation of the porous regions 52 and 54.

Other components capable of being produced by processes of the present invention include medical devices such as ceramic prosthetic devices containing void-containing layers and coatings formed in the presence of a gas-generating (or void-generating) agent.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A method comprising:
pre-placing or feeding a layer of a powdered material onto a surface of a substrate; and
heating the layer of the powdered material such that at least one gas-generating agent reacts to form at least one gaseous substance, to form a void-containing coating adhered to the surface of the substrate,
wherein:
the powdered material comprises a metallic material, a ceramic material, or both; and
the heating occurs with an energy beam.

2. The method of claim 1, further comprising:
melting the layer of the powdered material to form a melt pool; and
allowing the melt pool to cool and solidify to form the void-containing coating adhered to the surface of a superalloy substrate.

3. The method of claim 1, wherein the heating step comprises sintering the layer of the powdered material, to form a sintered coating adhered to the surface of a superalloy substrate.

4. The method of claim 1, wherein the gas-generating agent comprises an elemental metal, a metal alloy, a metal oxide, a metal hydride, a metal carbonate, a metal carbide, a metal halide, or a mixture thereof.

5. The method of claim 1, wherein the gas-generating agent comprises yttrium (Y), a yttrium oxide, or a mixture thereof.

6. The method of claim 1, wherein the powdered material further comprises the gas-generating agent.

7. The method of claim 1, further comprising adding the gas-generating agent after the heating step has been initiated.

8. The method of claim 1, wherein the heating of the layer of the powdered material occurs in the presence of at least one flux material comprising the gas-generating agent.

9. The method of claim 2, wherein:
the layer comprises the powdered material and a flux material comprising the gas-generating agent;
the melting forms the melt pool and a slag layer; and
upon cooling and solidification, at least one of the melt pool and the slag layer forms the porous coating.

10. The method of claim 9, wherein the flux material comprises CaF₂.

11. The method of claim 1, wherein the energy beam is a laser beam.

12. The method of claim 2, further comprising controlling the energy beam to impart motion to the melt pool, to entrain the gaseous substance in the solidifying melt pool.

13. The method of claim 1, further comprising, prior to the heating step, exposing the powdered material to humidity in order to retain water which, upon the heating, reacts with the gas-generating agent and the energy beam to form the at least one gaseous substance.

14. The method of claim 3, wherein the powdered material further comprises an exothermic agent which, upon heating with the energy beam, reacts over a time period to produce additional heat.

15. The method of claim 14, wherein the exothermic agent comprises an oxidizable metal, alloy or mixture of metals.

16. The method of claim 14, wherein different amounts of the exothermic agent are contained in different portions of the powdered material, such that a degree of sintering in corresponding portions of the sintered coating is different.

17. A method comprising forming at least one gaseous substance in a layer of a coating material comprising an inorganic material, while melting or sintering the layer with an energy beam, to form a void-containing layer adhered to a substrate.

18. The method of claim 17, wherein the gas-generating agent comprises an elemental metal, a metal alloy, a metal oxide, a metal hydride, a metal carbonate, a metal carbide, a metal halide, or a mixture thereof.

19. The method of claim 17, wherein the gas-generating agent comprises yttrium (Y), a yttrium oxide, or a mixture thereof.

20. The method of claim 17, wherein the melting or sintering occurs in the presence of flux material comprising the gas-generating agent.

21. A method comprising:
forming a portion of a device by successively depositing a plurality of layers of material by melting or sintering respective layers of material powder with an energy beam: and
controlling a composition of the powder in at least one of the layers such that the at least one of the layers is more crack resistant than other layers not so controlled.

22. The method of claim 21, further comprising controlling the composition of the powder in the at least one of the layers to comprise a gas-generating agent effective to generate porosity in the at least one of the layers during the melting or sintering.

23. The method of claim 22, wherein the gas-generating agent comprises a flux material.

24. The method of claim 22, wherein the gas-generating agent comprises an elemental metal, a metal alloy, a metal oxide, a metal hydride, a metal carbonate, a metal carbide, a metal halide or water.

25. A superalloy gas turbine engine component formed by the method of claim 21.
